(19) United States
(12) Patent Application Publication
(10) Pub. No.: US 2013/0262378 A1
(43) Pub. Date: Oct. 3, 2013

(54) AGGREGATION POINT FOR ENTERPRISE BUSINESS APPLICATION BINDING

(71) Applicants: Adam D. WILSON, Seattle, WA (US); Dipanjan GHOSH, Seattle, WA (US)

(72) Inventors: Adam D. WILSON, Seattle, WA (US); Dipanjan GHOSH, Seattle, WA (US)

(73) Assignee: Microsoft Corporation, Redmond, WA (US)

(21) Appl. No.: 13/437,010

(22) Filed: Apr. 2, 2012

(51) Int. Cl. G06F 17/30

(52) U.S. Cl. 707/611; 707/756; 707/E17.005; 707/E17.044

(57) ABSTRACT

Example apparatus and methods concern integrating external items (e.g., data, services) and an enterprise business application (EBA). Example apparatus and methods facilitate having an EBA describe an item for which external data or services are sought and then exposing the description. Example apparatus and methods also facilitate having a provider of external items register external items so that they can be discovered, evaluated, and bound to the EBA. Once an external item has been bound to an EBA item, then data may be automatically exchanged between the external item and the EBA under the control of a synchronization and transformation agent. Metadata-based descriptions of data items in two separate data models are collected in an aggregation point to break direct coupling of the two separate data models while facilitating flexible, extensible, re-definable indirect coupling through the aggregation point.

### BACKGROUND

Enterprises rely on ever-increasing amounts and types of data. As the amounts and types of data have increased, so too have the numbers and types of services relied on to process the data. As the number and types of data and services have increased, the complexity of managing the data and services has also grown. Therefore, enterprises have increasingly turned to enterprise business applications (EBAs) to integrate data and services across an enterprise. An Enterprise Resource Planning (ERP) application is one example of an EBA.

Much information about the data and services to be integrated into an EBA can be known before the EBA is deployed and thus can be designed into the EBA. However, other data, information about data, and services may not be known before an EBA is deployed. These types of data and services cannot be designed into the EBA and are accessed in some other way. EBAs may therefore rely on reference data or external services to support, complement, or extend built-in functionality.

Conventional EBAs may have been configured in a “one-off” fashion by adding custom code for addressing one issue in one way. These conventional EBAs may have been designed with additional software that relied on a specific piece of external reference data that was available at a specific location via a specific interface or protocol. Similarly, an EBA may have been custom-coded with additional software to rely on a specific external service available at a specific location via a specific protocol to calculate a specific value.

Before additional software can be used, the additional software has to be found, designed, coded, or built in a timely or cost-effective manner. Then, after the additional software is found or built, the additional software still needs to be verified, validated, deployed, and maintained. Unfortunately, this type of custom integration with additional software directly couples systems, makes EBAs difficult to configure, requires significant efforts from systems integration personnel or programmers, requires ongoing maintenance by systems integration personnel, and makes EBAs vulnerable to changes in the custom crafted additional software.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Example apparatus and methods provide an aggregation point that facilitates integrating external items (e.g., reference data, services) and an EBA. The aggregation point decouples data models native to the EBA and native to providers of external items. The aggregation point may also decouple protocols native to the EBA or providers of external items. The aggregation point facilitates performing the binding of EBA items and external items outside proprietary systems.

Example apparatus and methods facilitate having an EBA describe an EBA item for which support from external items is desired. The EBA item may be described to the aggregation point using metadata. Example apparatus and methods also facilitate having external providers describe reference data or services to the aggregation point using metadata. Example apparatus and methods also facilitate discovering external data or services that are available for use by an EBA.

### BRIEF DESCRIPTION OF THE DRAWINGS

The accompanying drawings illustrate various example apparatus, methods, and other embodiments described herein. It will be appreciated that the illustrated element boundaries (e.g., boxes, groups of boxes, or other shapes) in the figures represent one example of the boundaries. In some examples one element may be designed as multiple elements or multiple elements may be designed as one element. In some examples, an element shown as an internal component of another element may be implemented as an external component and vice versa. Furthermore, elements may not be drawn to scale.

FIG. 1 illustrates an example aggregation point and an environment in which the example aggregation point may operate.

FIG. 2 illustrates an example aggregation point.

FIG. 3 illustrates an example method associated with an aggregation point for EBA binding.

FIG. 4 illustrates an example method associated with an aggregation point for EBA binding.

FIG. 5 illustrates an example mapping.

FIG. 6 illustrates an example apparatus associated with an aggregation point for EBA binding.

FIG. 7 illustrates an example method associated with an aggregation point service.

FIG. 8 illustrates an example cloud operating environment.

FIG. 9 illustrates an example mobile device.

### DETAILED DESCRIPTION

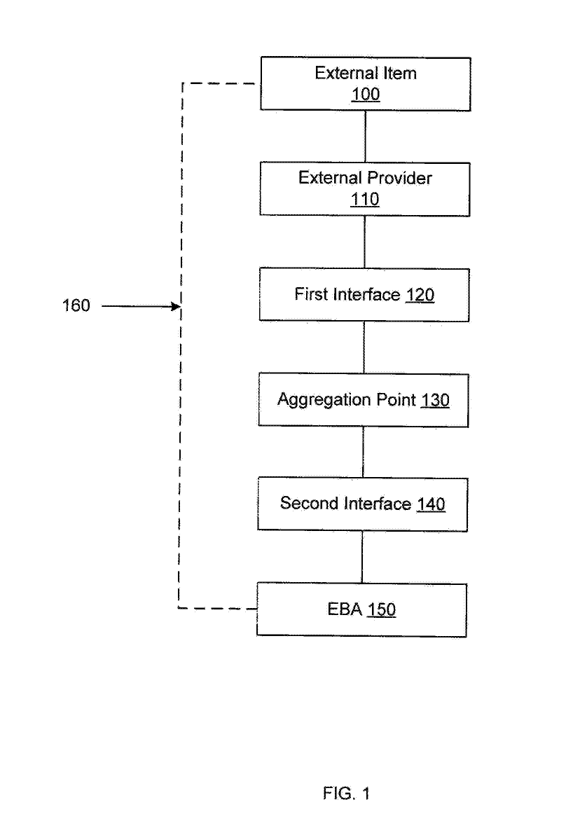

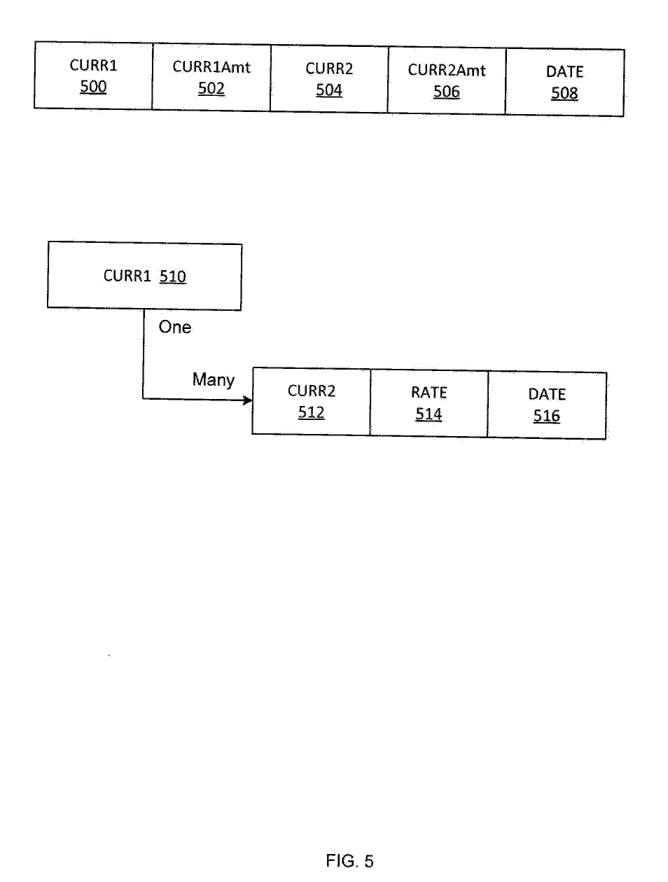

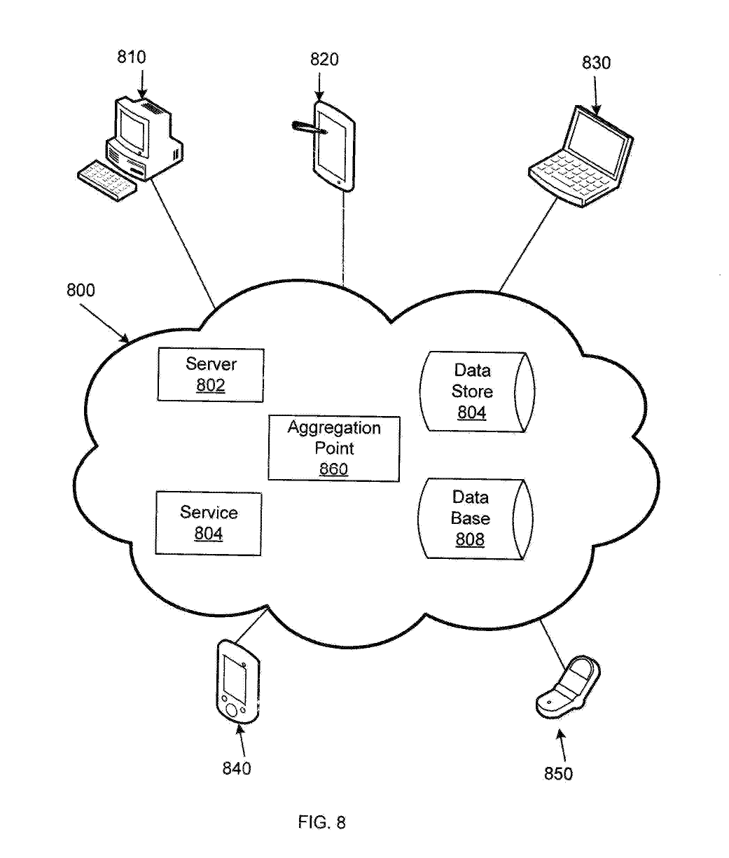

Example apparatus and methods provide an aggregation point and aggregation point services that facilitate automatically integrating external items (e.g., reference data, services) and an enterprise business application (EBA). FIG. 1 illustrates an example aggregation point 130 and an environment in which the aggregation point 130 may operate. Aggregation point 130 may be positioned between an EBA 150 and an external provider 110. Aggregation point 130 may provide, support, or interact with at least two different interfaces. A provider 110 of an external item 100 may use a first interface 120 to register the external item 100 with the aggregation point 130 for use by the EBA 150. The EBA 150 may use the second interface 140 to interact with the aggregation point 130 to gain access to the external item 100 that was registered through the first interface 120. The first interface 120 may be referred to as a “publisher portal” and the second interface 140 may be referred to as an “EBA interface”. The two interfaces decouple the EBA 150 from the external item 100. Decoupling the EBA 150 from the external item 100 may include decoupling data models or protocols for exchanging data. The two interfaces facilitate locating the aggregation point 130 outside the EBA 150. In one embodiment the aggregation point 130 may even be pushed into the cloud. The “cloud” refers to delivery of computing as a service over a network. More detail about “the cloud” is provided in connection with FIG. 8. A user may not need to be aware of the location or details of the computing infrastructure that provides the service in the cloud. While aggregation point 130 is described at an abstract level, specific examples are provided below in connection with FIG. 5.

In one embodiment, the first interface 120 may accept metadata from the external provider 110. The metadata may describe the external item 100, which may be associated with a first data model that is native to the external provider 110. The second interface 140 may accept metadata from the EBA 150. The metadata may describe an EBA item found in a second data model that is native to the EBA 150. In one embodiment, the metadata describing the external item 100 or the EBA item 150 may be XML-based. While extensible markup language (XML) is described, other metadata-based approaches may be employed.

The aggregation point 130 is configured to bridge gaps between data models or protocols. To facilitate bridging the gaps, the aggregation point 130 may receive a metadata mapping that describes how to relate items. The aggregation point 130 may also receive a metadata-based transform that describes how to transform a portion of the external item 100 to an EBA item or vice versa. The transformation can be performed at the aggregation point 130 using the metadata mapping or the metadata-based transform. The transformation may be performed external to the EBA 150. In different examples the metadata-based mapping or transform could be provided by the EBA 150, by the external provider 110 of the external item 100, or by a third party. In one embodiment, the transformation may be performed as a cloud computing service. The decoupling achieved by the aggregation point 130 facilitates having the EBA 150 appear to have a direct connection 160 to an external item 100.

Therefore, more generally, an aggregation point may be configured with a flexible metadata-based description framework that facilitates understanding data from the point of view of an EBA data model and understanding external items from the point of view of an external provider's data model. The metadata-based description framework may include a mapping that describes how to relate external items to EBA items and may include a transform that describes how to transform data from one data model to another data model. The metadata-based description framework may also include information concerning resolving different protocols for exchanging data. When a suitable external item, a suitable mapping, and a suitable transform have been discovered and understood, example apparatus and methods may use the aggregation point to bind the external item to an EBA item.

“Binding” refers to activating an integration solution at the aggregation point. After the external item and the EBA item are bound, data may then be exchanged between the EBA and the external item. Exchanging the data may involve mapping between data models and resolving protocol differences. Rather than having just a one-time exchange at binding, the aggregation point may be configured with a metadata-based synchronization framework, agent, process or other logic configured to co-ordinate and control ongoing data exchanges. The metadata-based synchronization framework may also facilitate automatically responding to changes in either the EBA or the external data and services. For example, the description of the EBA item may change in its data model or the description of an external item may change in its data model. Instead of these types of changes requiring customized code—as may be required in conventional systems—a change to a portion of a data model may be described to the aggregation point using metadata.

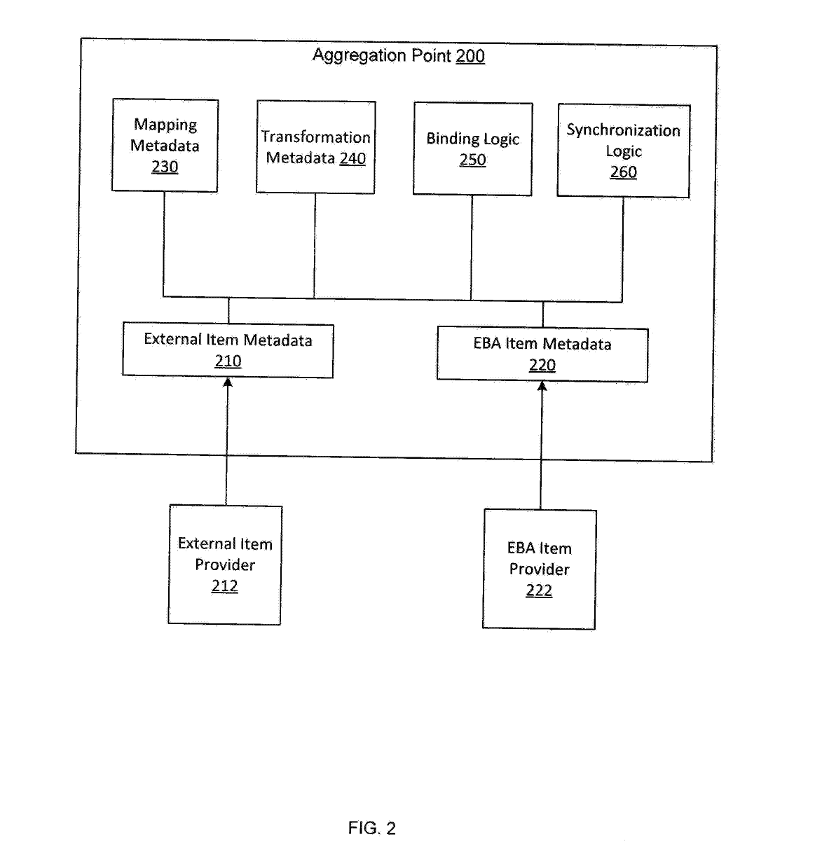

FIG. 2 illustrates an example aggregation point 200 that accepts and stores external item metadata 210 from an external item provider 212. Aggregation point 200 also accepts and stores EBA item metadata 220 from EBA item provider 222. Aggregation point 200 also stores or has access to mapping metadata 230 that describes how to resolve differences between the items described by the external item metadata 210 and the EBA item metadata 220. The differences may be resolved using transformation metadata 240. Aggregation point 200 may control binding logic 250 to bind the items. Binding logic 250 may use the metadata mapping 230 and the transformation metadata 240 to achieve the binding. Binding may include creating a service in the EBA. The service in the EBA can be configured to control exchanging data with the external item as controlled by a transformation in the aggregation point. Binding may also include controlling a transformation service, process, or logic to move data between the EBA and the external item according to the mappings provided in the aggregation point. Once the binding is achieved, aggregation point 200 may control synchronization logic 260 to maintain the binding and to keep the bound items synchronized. Establishing the binding changes the two standalone items (e.g., EBA item, eternal item) into an integrated item. In one embodiment, the aggregation point 200 may reside entirely inside a single service or entirely on a single computer. In another embodiment, the aggregation point 200 may be distributed between two or more services or two or more computers. In yet another embodiment, the aggregation point 200 may be provided as a service in the cloud.

Some portions of the detailed descriptions that follow are presented in terms of algorithms and symbolic representations of operations on data bits within a memory. These algorithmic descriptions and representations are used by those skilled in the art to convey the substance of their work to others. An algorithm is considered to be a sequence of operations that produce a result. The operations may include creating and manipulating physical quantities that may take the form of electronic values. Creating or manipulating a physical quantity in the form of an electronic value produces a concrete, tangible, useful, real-world result.

It has proven convenient at times, principally for reasons of common usage, to refer to these signals as bits, values, elements, symbols, characters, terms, numbers, and so on. It should be borne in mind, however, that these and similar terms are to be associated with the appropriate physical quantities and are merely convenient labels applied to these quantities. Unless specifically stated otherwise, it is appreciated that throughout the description, terms including processing, computing, and determining, refer to actions and processes of a computer system, logic, processor, or similar electronic device that manipulates and transforms data represented as physical quantities (e.g., electronic values).

Example methods may be better appreciated with reference to flow diagrams. For simplicity, the illustrated methodologies are shown and described as a series of blocks. However, the methodologies may not be limited by the order of the blocks because, in some embodiments, the blocks may occur in different orders than shown and described. Moreover, fewer than all the illustrated blocks may be required to implement an example methodology. Blocks may be combined or separated into multiple components. Furthermore, additional or alternative methodologies can employ additional, not illustrated blocks.

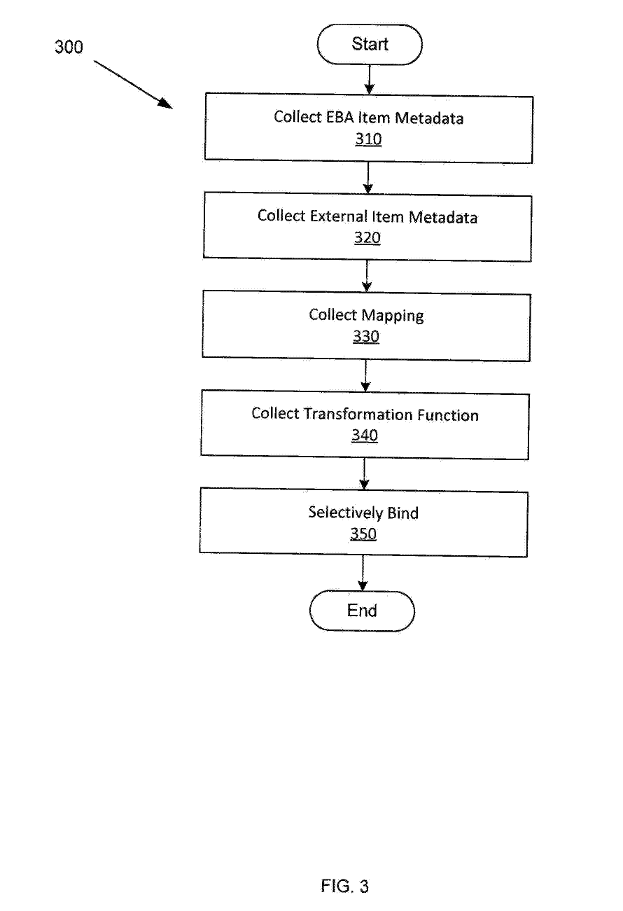

FIG. 3 illustrates an example method 300 associated with an example aggregation point for EBA binding. Method 300 includes, at 310, collecting a metadata-based description of an EBA data item into an aggregation point. The EBA item belongs to a first data model. The EBA may be, for example, an Enterprise Resource Planning (ERP) system and the first data model may be, for example, a schema that describes manufacturing data and processes. The metadata-based description of an EBA item may describe attributes including, but not limited to, the name of the EBA item, the data type (e.g., float, int) of the EBA item, dependencies between EBA items, relationships between EBA items, the names of EBA sub-items, the types of EBA sub-items, dependencies between EBA sub-items, relationships between EBA sub-items, parent-child relationships between an EBA item and EBA sub-items, and other attributes. The EBA may acquire or exchange data using a native protocol. Therefore, the metadata-based description of an EBA item may include information about a protocol used to handle that EBA item. The information may include, for example, error handling for the EBA item, data encoding for the EBA item, data decoding for the EBA item, and other protocol related information. Collecting a metadata-based description may include, for example, receiving data, receiving and storing data, accepting input data, accepting data from a process or service, or other action.

Method 300 also includes, at 320, collecting a metadata-based description of an external item into the aggregation point. The external item may belong to a second data model used by a provider of the external item. The second data model may be, for example, a schema that describes financial data. The external item may be, for example, a data item or a service. The metadata-based description of an external data item may describe items similar to those associated with the EBA item. The metadata-based description of an external service may describe, for example, inputs accepted by the external service, outputs produced by the external service, terms of use for the external service, costs associated with the external service, connection points for the external service, endpoints for the external service, error handling for the external service, data encoding instructions for the external service, data decoding instructions for the external service, and other attributes.

Method 300 also includes, at 330, collecting into the aggregation point a mapping that describes a mapping between the EBA data item and the external item. The mapping may describe which field in a first data model corresponds to a field in a second data model. Method 300 also includes, at 340, collecting into the aggregation point a metadata-based transformation function. The transformation function may describe how to compute a value for a field in a first data model using a field(s) in a second data model. Examples of a mapping and a transformation are described later in connection with FIG. 5.

Method 300 also includes, at 350, binding the EBA item to the external item. Binding the EBA item to the external item causes a data exchange between the items. The binding and exchange are based, at least in part, on the mapping and the transformation function. In one embodiment, the binding performed at 350 occurs outside an EBA. For example, the binding may occur in an EBA client, in a synchronization agent, in a service, in a cloud computing service, or elsewhere. Having an initial transfer of data at binding is useful. Having an ongoing transfer of data may be more useful.

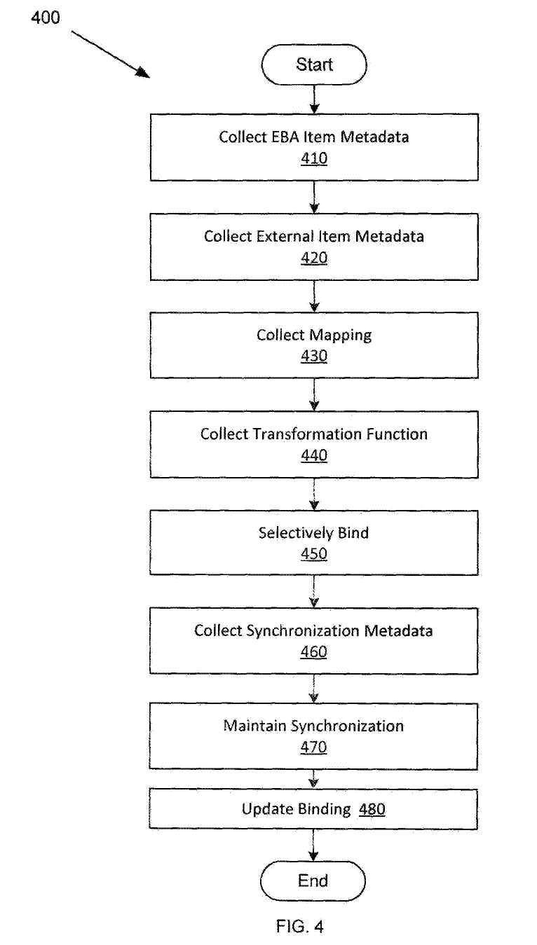

Therefore FIG. 4 illustrates an example method 400 that shares some actions with method 300 (FIG. 3). For example, method 400 includes collecting EBA item metadata at 410, collecting external item metadata at 420, collecting a mapping at 430, collecting a transformation function at 440, and binding at 450. Additionally, method 400 also includes actions 460, 470, and 480.

Method 400 includes, at 460, collecting synchronization metadata and, at 470, synchronizing the EBA item and the external item. The synchronization performed at 470 is controlled, at least in part, by the synchronization metadata collected at 460. The synchronization metadata may describe items including, but not limited to, an external item and an EBA item to synchronize, a time to perform synchronization, a direction to exchange data during synchronization, an approach for resolving synchronization conflicts, and a sequence for exchanging data.

An EBA may process different types of data and services for an enterprise. The data may include, for example, tax rates, lists of businesses, diagnostic codes, lists of states, lists of countries, universal product codes (UPC), and other types of data. Different industries may have different data sets and different data models. While several examples of data have been provided, different types of data that can be described by metadata may be employed. Services may include, for example, tax rate calculation services, geo-coding services, business information acquisition services, and other services. While several examples of services have been provided, different types of services that can be described by metadata may be employed. EBA services may create data that travels from an EBA, to an EBA, or in both directions. For example, an EBA service may provide a business name to a business information service and the business information service may return additional information (e.g., credit rating, number of employees) for the business.

In one embodiment, the interface between the external providers and the aggregation point may be configured to facilitate registering an external item. Collecting the external item metadata at 420 may include registering the external item. Registering an external data item may include defining how to ingest the data item, how to connect to the data item, how to expose the data item in a format usable to an EBA, cardinality for the data item, a direction in which data will be exchanged, and other actions. Describing how to connect to the data item may include, for example, providing a database connection string, providing credentials, providing security information, and other actions. Ingesting or consuming data may include reading the metadata, executing operations on data described by the metadata-based on the metadata, and other actions.

Registering an external data item may also include defining a mapping between the external data item and an EBA item. The mapping may be defined in terms of an EBA schema. To understand a mapping, consider that an external item has its format and structure and an EBA item has its format and structure. If the two structures are both known to the provider of the external item, then the provider can identify how the external item relates to the EBA item. The relation may be direct, where no transformation is required, or indirect, where a transformation function may be required. Registering an external data item may therefore include defining the transformation for resolving differences between an external item and an ERP item.

Registering an external service may include defining the service to be exposed by describing credentials to access the service, protocols associated with the external service, security employed by the external service, and other items. Defining the external service or data may also include describing terms of an offer for using the external item. The terms may include, but are not limited to, how the external item is to be displayed, the price for the external item, and the terms of service associated with the external item.

Over time, both data items and services may change. The changes may occur in either the EBA data model or the external data model. Since the aggregation point decouples the two data models and the systems that use the two data models, these types of changes can be accounted for in the aggregation point rather than in the systems themselves. In one embodiment, method 400 may therefore include, at 480, selectively updating the binding between the external item and the ERP item. Updating the binding at 480 may include collecting additional or up-to-date metadata concerning an external item, an EBA item, a mapping between items, or a transformation associated with the mapping.

While FIG. 4 illustrates various actions occurring in serial, it is to be appreciated that various actions illustrated in FIG. 4 could occur substantially in parallel. By way of illustration, a first process could populate an aggregation point and a second process could perform operations based on the metadata available to the aggregation point. While two processes are described, it is to be appreciated that a greater or lesser number of processes could be employed and that lightweight processes, regular processes, threads, and other approaches could be employed.

FIG. 5 illustrates two representations of a currency item and illustrates a difference between a mapping and a transformation. The first representation includes fields CURR1 500, CURR1Amt 502, CURR2 504, CURR2Amt 506, and DATE 508. CURR1 500 is the name of a currency (e.g., “USDollars”), CURR1Amt 502 is an amount of that currency available, CURR2 504 is the name of a second currency (e.g., “CDNDollars”), CURR2Amt 506 is an amount of that currency that would be available if the first currency was changed to the second currency, and DATE 508 is the date and time that the second currency amount was valid with respect to the first currency amount.

The second representation includes a parent field CURR1 510 that has a one-to-many relationship with sub-fields CURR2 512, RATE 514, and DATE 516. The two date fields may correspond directly and thus a direct mapping may be made between the two fields. The first representation may store amounts while the second representation may only store a rate. However, the second representation may provide information from which CURR2Amt 506 can be computed. Thus, it may be able to describe a transformation between the fields. The two representations may be used as described below.

Consider an EBA that may need to have available an exchange rate to support a financial service that computes a piece of financial data (e.g., current funds available for Canadian purchases). A particular exchange rate (e.g., US dollars to Canadian dollars) is data that may not be known when an EBA is deployed. The fact that the exchange rate will need to be calculated may be known, an equation for computing the current funds available for foreign purchase may be known, and even the EBA data model representation of the currency may be known. But the value of a variable (e.g., exchange rate) needed to resolve the equation may not be known at deployment time. Further complicating matters, exchange rates may be dynamic and change daily, hourly, or even more frequently. Example apparatus and methods may therefore provide an aggregation point that accepts a metadata-based representation of a currency item from the EBA data model point of view, that accepts a metadata-based representation of a currency item from an external provider data model point of view, and that accepts information for integrating the items.

Consider that an EBA may also be configured to perform a certain function (e.g., calculate sales tax) but also not have available at deployment time information about all the taxing authorities with which it will interact or all the rules for all the taxing authorities with which it will interact. For example, one item (e.g., clothing) may be taxable in one taxing authority but may not be taxable in another taxing authority. Additionally, tax rules and rates may also be dynamic. Therefore, the aggregation point may also accept a metadata-based representation of the tax rate calculation service desired by the EBA and may accept a metadata-based representation of the tax rate calculation service. The EBA will describe the service from the point of view of its data model. The external provider will describe its service from the point of view of its data model. If an acceptable transformation can be performed, metadata describing the mapping needed for the transformation can be provided to the aggregation point. In different examples the mapping may be provided by users of the EBA, by an external provider, or by a third party. In one example, data items, either EBA items or external reference items may be described using a hierarchical tree query.

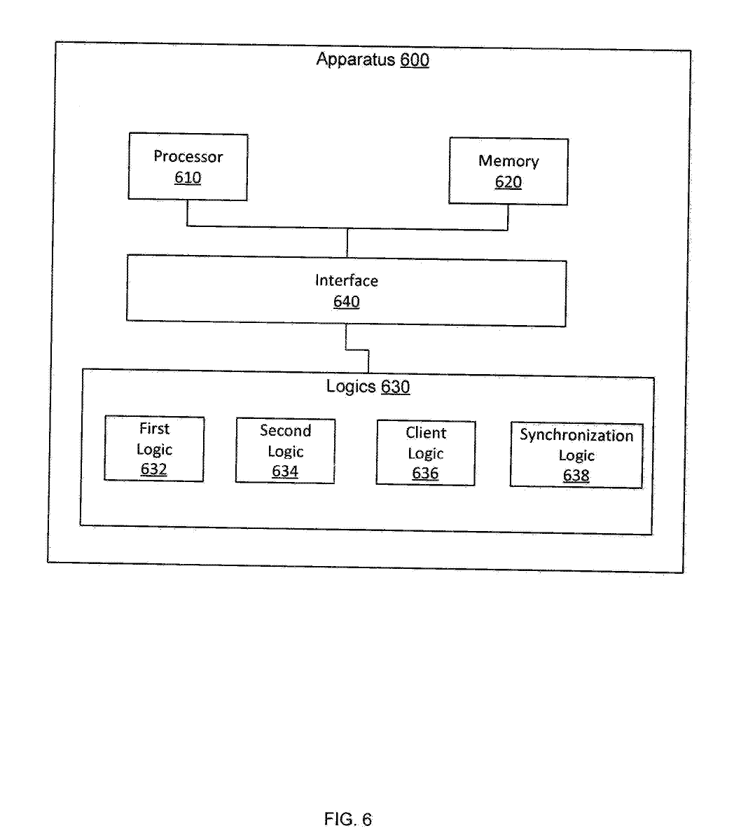

FIG. 6 illustrates an apparatus 600 that includes a processor 610, a memory 620, a set 630 of logics and an interface 640 that connects the processor 610, the memory 620, and the set 630 of logics. In one embodiment the apparatus 600 may be a general purpose computer that has been transformed into a special purpose computer through the inclusion of the set 630 of logics. The set 630 of logics may be configured to facilitate integrating external items and an enterprise resource planning (ERP) system. In one embodiment the methods described herein may be performed by apparatus 600. Apparatus 600 may interact with other apparatus, processes, and services through, for example, a computer network.

The set 630 of logics may include a first logic 632 that is configured to receive information into an aggregation point. The information will concern an external item that is to be made available to an ERP system. The first logic 632 may interact with a publisher portal interface to accept, store, validate, and expose the information concerning the external item. The information concerning the external item may include, for example, information concerning how to ingest an external data item, how to connect to the external data item, and how to expose the external data item. The information concerning the external item may also include a mapping between the external data item and an ERP data item, a transformation based on the mapping between the external data item and the ERP data item, terms of use for the external data item, and a price for using the external data item. When the external item is a service, the information concerning the external item may include an endpoint associated with an external service, an operation performed by the external service, a credential for accessing the external service, a data type to input to the external service, a data type to receive from the external service, a term of use for the external service, a protocol associated with the external service, security employed by the external service, and a price for using the external service.

The set 630 of logics may also include a second logic 634 that is also configured to receive information into the aggregation point. This information concerns an ERP item for which an external item is sought. The second logic 634 may be configured to interact with the ERP system to accept, store, validate, and expose the information concerning the ERP item.

The set 630 of logics may also include an ERP client logic 636 that is configured to provide an ERP client for binding the external item to the ERP item. The binding may be based, at least in part, on a metadata-based transformation and a metadata-based mapping between the external item and the ERP item. In one example, the ERP client binds the external item and the ERP item, which includes exchanging data from one item to another item as controlled by the metadata-based mapping and the metadata-based transformation.

The set 630 of logics may also include a synchronization logic 638 that is configured to provide a synchronization agent for synchronizing the ERP item and the external item. The synchronization agent may support post-binding exchanges between the external item and the ERP item by controlling one or more of, identifications of external items and ERP items to be synchronized, discrete times for synchronizing external items and ERP items, periods for synchronizing external items and ERP items, events that trigger synchronizing external items and ERP items, direction of travel for data exchanged during a synchronization, a synchronization conflict resolution protocol, and an order in which data is exchanged during synchronization.

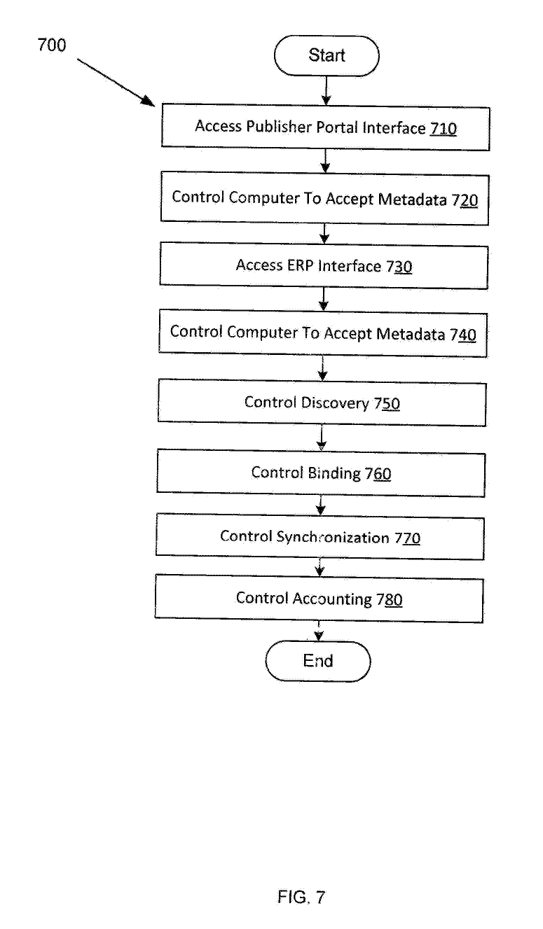

FIG. 7 illustrates a method 700 associated with an aggregation point service. Method 700 may include, at 710, controlling a computer to access a publisher portal interface that is configured to register an external item. Method 700 may also include, at 720, controlling the computer to accept metadata concerning the external item through the publisher portal interface. The accepted metadata may be stored in a data store.

Method 700 also includes, at 730, accessing an ERP interface that is configured to accept, validate, publish, and store metadata concerning an ERP item. Method 700 also includes, at 740, controlling the computer to accept metadata concerning the ERP item through the ERP interface and to store it in a data store. In one embodiment, the ERP interface facilitates looking for, examining, requesting, managing, and purchasing external items that have been made available to the ERP system in the aggregation point through the publisher portal. In different embodiments, the ERP interface can be accessed through a web browser, through an ERP system, via a set of application programming interfaces (API), and in other ways. A web browser embodiment of the first interface may be linked to the ERP system. A native embodiment of the first interface may be embedded in the ERP system. Embedding the ERP interface or linking to the ERP interface may include interacting with the ERP interface through a set of APIs or libraries. In one embodiment, the ERP interface may only display or otherwise make available external items that have been validated by an ERP client.

With the two sets of metadata available, method 700 may proceed, at 750, to control the computer to determine whether the external item is suitable for binding to the ERP item. The determination may be based, at least in part, on discovering a mapping or transformation between the external item and the ERP item. If a suitable mapping and transformation are found, then method 700 may proceed, at 760, to control the computer to establish a binding between the external item and the ERP item.

Method 700 may also include, at 770, controlling the computer to maintain synchronization between the external item and the ERP item. Binding to and using an external item may not be free. Therefore method 700 may include, at 780, controlling the computer to account for use of the external item. Accounting for the use may include, for example, tracking a number of times an item is accessed, tracking a number of times an item is updated, and other actions.

In one example, a method may be implemented as computer executable instructions. Thus, in one example, a computer-readable storage medium may store computer executable instructions that if executed by a machine (e.g., computer) cause the machine to perform methods described herein including method 700. While executable instructions associated with the above method are described as being stored on a computer-readable storage medium, it is to be appreciated that executable instructions associated with other example methods described herein may also be stored on a computer-readable storage medium.

“Computer-readable storage medium”, as used herein, refers to a medium that stores instructions or data. “Computer-readable storage medium” does not refer to propagated signals. A computer-readable storage medium may take forms, including, but not limited to, non-volatile media, and volatile media. Non-volatile media may include, for example, optical disks, magnetic disks, tapes, and other media. Volatile media may include, for example, semiconductor memories, dynamic memory, and other media. Common forms of a computer-readable storage medium may include, but are not limited to, a floppy disk, a flexible disk, a hard disk, a magnetic tape, other magnetic medium, an ASIC, a CD, other optical medium, a RAM, a ROM, a memory chip or card, a memory stick, and other media from which a computer, a processor or other electronic device can read.

FIG. 8 illustrates an example cloud operating environment 800. A cloud operating environment 800 supports delivering computing, processing, storage, data management, applications, and other functionality as an abstract service rather than as a standalone product. Services may be provided by virtual servers that may be implemented as one or more processes on one or more computing devices. In some embodiments, processes may migrate between servers without disrupting the cloud service. In the cloud, shared resources (e.g., computing, storage) may be provided to computers including servers, clients, and mobile devices, over a network. Different networks (e.g., Ethernet, Wi-Fi, 802.x, cellular) may be used to access cloud services. Users interacting with the cloud may not need to know the particulars (e.g., location, name, server, database) of a device that is actually providing the service (e.g., computing, storage). Users may access cloud services via, for example, a web browser, a thin client, a mobile application, or in other ways.

FIG. 8 illustrates an example aggregation point 860 residing in the cloud 800. The aggregation point 860 may rely on a server 802 or service 804 to perform processing and may rely on a data store 804 or database 808 to store data. While a single server 802, a single service 804, a single data store 804, and a single database 808 are illustrated, multiple instances of servers, services, data stores, and databases may reside in cloud 800 and may, therefore, be used by aggregation point 860.

FIG. 8 illustrates various devices accessing aggregation point 860 in the cloud 800. The devices include a computer 810, a tablet 820, a laptop computer 830, a personal digital assistant 840, and a mobile device (e.g., cellular phone, satellite phone) 850. The aggregation point 860 facilitates binding an external item to an EBA item for use by an EBA (e.g., ERP system). Thus, it is possible that different users at different locations using different devices may access the aggregation point 860 through different networks or interfaces. In one example, aggregation point 860 may be accessed by a mobile device 850. In another example, portions of aggregation point 860 may reside on a mobile device 850.

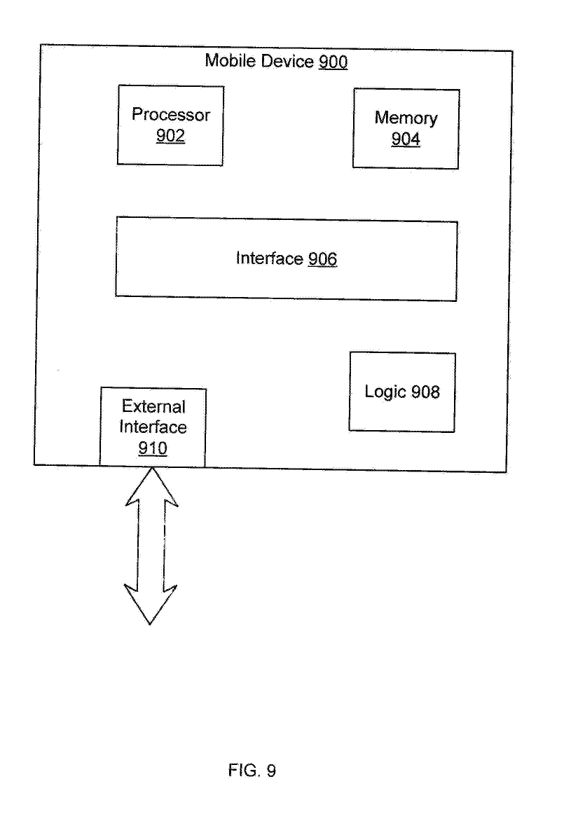

FIG. 9 illustrates an example mobile device 900. Mobile device 900 includes a processor 902, a memory 904, a logic 908, and an external interface 910 that may be connected by an interface 906. Mobile device 900 may be, for example, a cellular telephone, a network telephone, a satellite telephone, or other device.

Generally describing an example configuration of the mobile device 900, the processor 902 may be a variety of various processors including dual microprocessor and other multi-processor architectures. The memory 904 may include volatile memory or non-volatile memory. Non-volatile memory may include, for example, read only memory (ROM), programmable ROM (PROM), and other memory. Volatile memory may include, for example, random access memory (RAM), dynamic RAM (DRAM), and other memory. The memory 904 can store an operating system that controls and allocates resources of the mobile device 900.

The interface 906 may be a single internal bus interconnect architecture or other bus or mesh architectures. While a single bus is illustrated, it is to be appreciated that the mobile device 900 may communicate with various devices, logics, and peripherals using other busses (e.g., PCIE, 1394, USB, Ethernet). The interface 906 can be types including, for example, a memory bus, a memory controller, a peripheral bus, an external bus, a crossbar switch, or a local bus.

The mobile device 900 can operate in a network environment and thus may be connected to a network through network devices via the external interfaces 910. The mobile device 900 may be logically connected to remote computers through the network and the network devices. Through the network, the mobile device 900 may also be connected to services provided in the cloud. Networks with which the mobile device 900 may interact include, but are not limited to, a LAN, a WAN, a telephony network, a telephony system, a cellular system, a satellite system, and other networks.

Mobile device 900 may include a special purpose logic 908 that is configured to provide a functionality for the mobile device 900. For example, logic 908 may provide a client for interacting with an aggregation point.

The following includes definitions of selected terms employed herein. The definitions include various examples or forms of components that fall within the scope of a term and that may be used for implementation. The examples are not intended to be limiting. Both singular and plural forms of terms may be within the definitions.

References to “one embodiment”, “an embodiment”, “one example”, and “an example” indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Data store”, as used herein, refers to a physical or logical entity that can store data. A data store may be, for example, a database, a table, a file, a list, a queue, a heap, a memory, a register, and other physical repository. In different examples, a data store may reside in one logical or physical entity or may be distributed between two or more logical or physical entities.

“Logic”, as used herein, includes but is not limited to hardware, firmware, software in execution on a machine, or combinations of each to perform a function(s) or an action(s), or to cause a function or action from another logic, method, or system. Logic may include a software controlled microprocessor, a discrete logic (e.g., ASIC), an analog circuit, a digital circuit, a programmed logic device, a memory device containing instructions, and other physical devices. Logic may include one or more gates, combinations of gates, or other circuit components. Where multiple logical logics are described, it may be possible to incorporate the multiple logical logics into one physical logic. Similarly, where a single logical logic is described, it may be possible to distribute that single logical logic between multiple physical logics.

To the extent that the term “includes” or “including” is employed in the detailed description or the claims, it is intended to be inclusive in a manner similar to the term “comprising” as that term is interpreted when employed as a transitional word in a claim.

To the extent that the term “or” is employed in the detailed description or claims (e.g., A or B) it is intended to mean “A or B or both”. When the Applicant intends to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

To the extent that the phrase “one or more of, A, B, and C” is employed herein, (e.g., a data store configured to store one or more of, A, B, and C) it is intended to convey the set of possibilities A, B, C, AB, AC, BC, or ABC (e.g., the data store may store only A, only B, only C, A&B, A&C, B&C, or A&B&C). It is not intended to require one of A, one of B, and one of C. When the applicants intend to indicate “at least one of A, at least one of B, and at least one of C”, then the phrasing “at least one of A, at least one of B, and at least one of C” will be employed.

Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing the claims.

What is claimed is:

1. A method, comprising:
collecting a metadata-based description of an enterprise business application (EBA) item into an aggregation point, the EBA item belonging to a first data model;
collecting a metadata-based description of an external item into the aggregation point, the external item belonging to a second different data model;
collecting into the aggregation point a mapping that describes a mapping between the EBA item and the external item;
collecting into the aggregation point a metadata-based transformation function that describes a transformation between the EBA item and the external item; and
binding the EBA item to the external item based, at least in part, on the metadata-based description of the EBA item, the metadata-based description of the external item, the mapping, a channel for retrieving the external item, and the metadata-based transformation function,
where the binding occurs at the aggregation point outside the EBA.

2. The method of claim 1, comprising controlling the aggregation point to perform the binding as a cloud computing service.

3. The method of claim 1, comprising:
collecting synchronization metadata into the aggregation point, and
maintaining synchronization between the EBA item and the external item based, at least in part, on the synchronization metadata.

4. The method of claim 3, where the synchronization metadata describes one or more of, an external item and an EBA item to synchronize, a synchronization time, a direction to exchange data during synchronization, a protocol for resolving a synchronization conflict, and a sequence for exchanging data.

5. The method of claim 1, where the metadata-based description of the external item describes one or more of, a name of an external data item, a type of the external data item, a dependency between two or more external data items, a relationship between two or more external data items, a name of an external data sub-item, a type of an external data sub-item, a dependency between two or more external data sub-items, a relationship between two or more external data sub-items, a parent-child relationship between the external data item and an external data sub-item, and a cardinality of a relationship between the external data item and an external data sub-item.

6. The method of claim 1, where the metadata-based description of the EBA item describes one or more of, a name of the EBA item, a type of the EBA item, a dependency between two or more EBA items, a relationship between two or more EBA items, a name of an EBA sub-item, a type of an EBA sub-item, a dependency between two or more EBA sub-items, a relationship between two or more EBA sub-items, a parent-child relationship between the EBA item and an EBA sub-item, a cardinality of a relationship between the EBA item and an EBA sub-item, information about a protocol used to handle the EBA item, error handling information for the EBA item, data encoding instructions for the EBA item, and data decoding instructions for the EBA item.

7. The method of claim 1, where the metadata-based description of the external item describes one or more of, inputs accepted by an external service, outputs produced by the external service, terms of use for the external service, costs associated with the external service, connection points for the external service, endpoints for the external service, error handling for external service, data encoding instructions for the external service, and data decoding instructions for the external service.

8. The method of claim 1, the external item being one of, a tax rate, a business name, a business address, a diagnostic code, a universal product code (UPC), a currency exchange rate, an investment symbol, a location, financial data, accounting data, manufacturing data, sales data, customer relationship management (CRM) data, planning data, supply chain data, human resources data, a tax calculator, a sales tax rate calculator, a geo-coder, an address verifier, a shipping rate calculator, a business intelligence service, a customizable reporting service, a document management service, an analysis service, a data acquisition service, a data update service, a scheduling service, and a planning service.

9. The method of claim 1, comprising registering an external data item in the aggregation point by defining one or more of, how to ingest the external data item, how to connect to the external data item, how to expose the external data item, a mapping between the external data item and the EBA item, a transformation based on the mapping between the external data item and the EBA item, a term of use of the external data item, and a price for using the external data item.

10. The method of claim 1, comprising registering an external service in the aggregation point by defining one or more of, a credential for accessing the external service, a protocol for accessing the external service, security associated with the external service, and a price for using the external service.

11. The method of claim 1, comprising selectively updating the binding between the external item and the EBA item upon determining that there has been a change in one or more of, the metadata-based description of the EBA item, the metadata-based description of the external item, the metadata-based mapping, and the metadata-based transformation function.

12. The method of claim 1, the aggregation point being distributed between two or more computers or between two or more services.

13. An apparatus, comprising:
a processor;
a memory;
a set of logics configured to facilitate integrating external items and an enterprise resource planning (ERP) system; and
an interface that connects the processor, the memory, and the set of logics,
the set of logics comprising:
a first logic configured to receive into an aggregation point information concerning an external item that is to be made available to the ERP system;
a second logic configured to receive into the aggregation point information concerning an ERP item for which an external item is sought;
an ERP client logic configured to provide an ERP client for binding the external item to the ERP item based, at least in part, on a metadata-based transformation or a metadata-based mapping between the external item and the ERP item; and
a synchronization logic configured to provide a synchronization agent for synchronizing the ERP item and the external item.

14. The apparatus of claim 13, where the first logic interacts with a publisher portal interface to accept, store, validate, and expose the information concerning the external item.

15. The apparatus of claim 13, where the first logic is configured to receive information including how to ingest an external data item, how to connect to the external data item, how to expose the external data item, a mapping between the external data item and the ERP item, a transformation based on the mapping between the external data item and the ERP item, a term of use of the external data item, a price for using the external data item, an endpoint associated with an external service, an operation performed by the external service, a credential for accessing the external service, a data type to input to the external service, a data type to receive from the external service, a term of use for the external service, and a price for using the external service.

16. The apparatus of claim 13, where the second logic interacts with the ERP system to accept, store, validate, and expose the information concerning the ERR item.

17. The apparatus of claim 13, where the ERP client binds the external item and the ERP item, where binding the external item and the ERP item includes exchanging data between the external item and the ERP item as controlled by the metadata-based mapping and the metadata-based transformation.

18. The apparatus of claim 13, where the synchronization agent supports post-binding exchange of data between the external item and the ERP item by controlling one or more of, identifications of external items and EBA items to be synchronized, discrete times for synchronizing external items and EBA items, periods for synchronizing external items and EBA items, events that trigger synchronization, direction of travel for data exchanged during a synchronization, resolving conflicts between synchronizations, and an order in which data is exchanged during synchronization.

19. The apparatus of claim 13, comprising an ERP interface logic that provides an ERP interface configured to be accessed through one or more of, a web browser, an application programming interface (API) associated with the ERP system, an API associated with a third-party application, a library associated with the ERP system, and a library associated with a third party application.

20. A computer-readable storage medium storing computer-executable instructions that when executed by a computer control the computer to perform a method, the method comprising:
accessing a publisher portal interface configured to register an external item associated with a first data model;
controlling the computer to accept metadata concerning the external item through the publisher portal interface and to store the metadata concerning the external item in a data store;
accessing an ERP interface configured to accept, validate, publish, and store metadata concerning an ERP item associated with a second, different data model;
controlling the computer to accept metadata concerning the ERP item through the ERP interface and to store the metadata concerning the ERP item in the data store;
controlling the computer to determine whether the external item is suitable for binding to the ERP item based, at least in part, on discovering a mapping or transformation between the external item and the ERP item;
controlling the computer to selectively establish a binding between the external item and the exposed ERP item, where the binding includes an initial exchange of data;
controlling the computer to maintain synchronization between the external item and the ERP item, where the synchronization includes post-binding exchanges of data; and
controlling the computer to account for use of the external item.
